(19) United States
(12) Patent Application Publication
(10) Pub. No.: US 2005/0005409 A1
(43) Pub. Date: Jan. 13, 2005

(54) Portable grave time capsule

(76) Inventor: Gil Elnatan, New York, NY (US)

Correspondence Address: AMSTER, ROTHSTEIN & EBENSTEIN;90 PARK AVENUE, NEW YORK, NY, 10016, US

(21) Appl. No.: 10/602,496

(22) Filed: Jun. 24, 2003

(51) Int. Cl. A61G 17/00

(52) U.S. Cl. 27/1

(57) ABSTRACT

A method of burial includes collecting and containing physical remains including cremated ashes and non-cremated DNA material of a deceased person, collecting in a memory device digitized data on the biographical and medical history of the deceased person, providing a sealable time capsule to contain the physical remains and the digitized data, and providing a communication terminal on the time capsule for accessing, uploading and downloading the digitized data.

### FIELD OF THE INVENTION

This invention is in the field of burial rituals and procedures for the deceased, and memorializing and establishing eternal records of the lives of the deceased.

### PRIOR ART

Burial rituals have existed, of course, for centuries in most cultures. The ones of most pertinent interest in this application are the conventional burials in caskets placed in the ground and cremation of bodies into ashes and then retained in urns.

With regard to traditional burials in caskets, there are, besides the spiritual and emotional aspects, some very practical aspects of worldwide concern. In many areas land is at a premium and cemeteries occupy and consume a considerable amount of such precious land, and this consumption of land continues and increases each year. Furthermore, this kind of burial in caskets consumes great amounts of wood, often valuable hardwood, not to mention the substantial cost of conducting such burials and of maintaining cemeteries. Thus, in addition to the financial costs and burdens for these traditional burials, there are ecological consequences on a global scale.

A still further consideration is the inconvenience and pain to the bereaved that the burial sites are usually very far from their homes. While this may be solved in part by having cremated remains in nearby urns, the present invention seeks to have a more far-reaching favorable alternative for the surviving family members and friends.

Still additional forms of burial are cryonic preservation which may cost even more than traditional burials in caskets in traditional cemeteries, and sending cremated remains into orbit or into outer space.

### OBJECTS AND SUMMARY OF THE NEW INVENTION

One object of this invention is to provide a portable grave which is far more than an urn of cremated remains, but includes other elements which can bring the surviving relatives and friends closer to the essence of the deceased. In place of a full scale traditional burial with a casket in a fixed location in a grave consuming land, this new invention is a form of time capsule which contains a small quantity of the cremated ashes, a small element of the deceased's hair, fingernail or other appropriate body remnant to provide actual DNA material, and in a digital memory device biographical data, medical history data, digitized DNA data and data on related family members. The capsule may further include video, photographic, voice and holographic data of the deceased and also messages from the deceased in any of the above-noted media. Also, as a part of this capsule is a digital memory media that stores all the data relevant to this deceased's prior life.

It is a further object for this time capsule to be very small, portable and aesthetically pleasing so that owners of same can have it in or near their homes for the emotional closeness and for access to historical data by coupling the capsule to a computer, and also for determining or verifying or researching family lineage via the DNA material or the family tree information.

It is a further object to be able to link a plurality of these capsules of different family members via single or multiple computers to establish or expand the data in one capsule from another capsule or to create a family tree.

A still further object is to make a time capsule that is capable and suitable for cloning the deceased, if and when such becomes possible, should that be the desire of the deceased or of the descendants. With a time capsule of this type one would have not only the digitized DNA data, but actual DNA material and a medical and biographical history associated with this prior life for use with the cloned new life.

An additional object is to provide an alternative to the massive consumption of wood for caskets and land for cemeteries.

Another object of this invention is to provide an alternate form of burial where the bereaved can have a combination of physical remains, and full biographical and medical history instantly available along with the person's DNA, leading to a spiritual closeness that could not be achieved by a distant cemetery or a nearby urn of cremated ashes. Thus, this invention is not merely a substitute for a casket or a cremation urn, but in fact is an alternate from of burial that at once provides vastly greater opportunities for maintaining a sense of connection with the deceased, and for participating in local and global level efforts for ecological and conservation goals regarding forests and land consumption.

In keeping with the eternity of the spirit, these new portable grave time capsules are made of materials such as titanium, brass or stainless steel which last essentially forever. The digital internal memory devices can be activated at any later date, and the actual DNA material will be preserved appropriately within the time capsule for use at such future date.

In a further embodiment of this invention the time capsule may omit the cremated ashes or other of the above-listed components, leaving whatever may be deemed sufficient connection to the deceased to constitute an alternate burial and memorialization.

The new invention provides Eternal Entombment which includes the following benefits:
(a) Eternal Entombment is science and religion in harmony. It does not conflict with conventional burial or any religious belief. Traditional practices such as interment, cremation and donation to medical science go hand in hand with Eternal Entombment.
(b) Eternal Entombment goes side by side with traditional burial.
(c) Eternal Entombment is a cheaper alternative to conventional burial. According to funeral estimates, the average cost of a conventional funeral runs around $5,000. At a considerably lower average cost Eternal Entombment can save consumers thousands of dollars.
(d) Eternal Entombment is earth friendly. Every year Americans bury more than two million loved ones in the nation's 23,000 cemeteries. However, along with remains, we also bury more than 14,000 tons of steel and 90,000 tons of concrete in casket vaults, 2,400 tons of copper and bronze in the form of coffins and more than 30 million board feet of prime hardwoods. Add to that more than 800,000 gallons of toxic embalming fluid.
(e) Eternal Entombment saves valuable space for future generations,
(f) Eternal Entombment can keep family members closer to loved ones.
(g) Eternal Entombment includes a capsule designed to withstand the test of time. A preferred capsule is compact, having dimensions of approximately 3⅝″×2⅝×1″. Such capsule may be made of titanium, brass or stainless steel which can withstand the test of time, natural disasters, wars, vandalism, etc.
(h) Eternal Entombment is flexible for individuals and family sharing, in being easily portable, storable and viewable regardless of the geographical location of family members.
(i) Eternal Entombment capsules are available in multiple units for all family members if so desired.
(j) Eternal Entombment capsules are built for modular assembly, designed to easily connect to each other to facilitate creation of a family tree.
(k) Eternal Entombment capsules store individual DNA profiles which can be used for positive identification, medical research and future disease prevention or cloning. In recent years DNA has proven to be the best form of identification. In addition, DNA is robust and stable, and unlike photographs or fingerprints it does not degenerate with time.
(l) Eternal Entombment capsules help preserve and transfer a person's previous legacy and personal biography to the future through digital media (audio, video and pictures). This information is easily accessible at any time, giving family members the opportunity to commemorate and reminisce.
(m) Eternal Entombment helps one to prepare for burial while he or she is still alive. This relieves family members from the emotional and financial burden of arranging a funeral.

One embodiment of the present invention may be summarized as a method of burial which includes the steps of:
(a) collecting and containing physical remains including cremated ashes and non-cremated remains DNA material of a deceased person,
(b) collecting in a memory device digitized data on the biographical and medical history of the deceased person,
(c) providing a sealable time capsule to contain the physical remains and the digitized data, and
(d) providing a communication terminal on the time capsule for accessing, uploading and downloading the digitized data.

A further embodiment of the present invention is a method to enhance the environment by conserving land space and conserving trees, by an alternate form of burial which includes the steps of:
(a) collecting and containing physical remains including cremated ashes and non-cremated DNA material of a deceased person,
(b) collecting in a memory device digitized data on the biographical and medical history of the deceased person,
(c) providing a sealable time capsule to contain said physical remains and the digitized data, and
(d) providing a communication terminal on said time capsule for accessing, uploading and downloading the digitized data.

The above and related objects, features and advantages of the present invention will be more fully understood by reference to the detailed description of the presently preferred, albeit illustrative, embodiments of the present invention when taken in conjunction with the accompanying drawings herein.

### BRIEF DESCRIPTION OF THE DRAWINGS

FIG. 1 is a top front perspective view of the new Portable Grave Time Capsule in a presentation box,

FIG. 2 is a front elevation view of the Portable Grave Time Capsule of FIG. 1.

FIG. 2A is a three dimensional view of the capsule and its contents,

FIG. 3 is a rear elevation view thereof,

FIG. 4 is a bottom plan view thereof,

FIG. 5 is a top plan view thereof,

FIG. 6 is a left side elevation view thereof,

FIG. 7 is a right side elevation view thereof,

FIG. 8 is a front elevation view exploded and in section taken along the line 8-8 in FIG. 4 of a compartment and the tube for DNA or other material,

FIG. 8A is a side elevation view of the tube of FIG. 8 for DNA or other material,

FIG. 9 is a front elevation view exploded and in section taken along line 9-9 in FIG. 4 of a compartment and the USB digital media,

FIG. 9A is a side elevation view of the USB digital media seen in FIG. 9, and

FIG. 10 is a schematic diagram of the steps in establishing the Portable Grave Time Capsule of FIGS. 1-9.

### DETAILED DESCRIPTION OF THE PREFERRED EMBODIMENTS

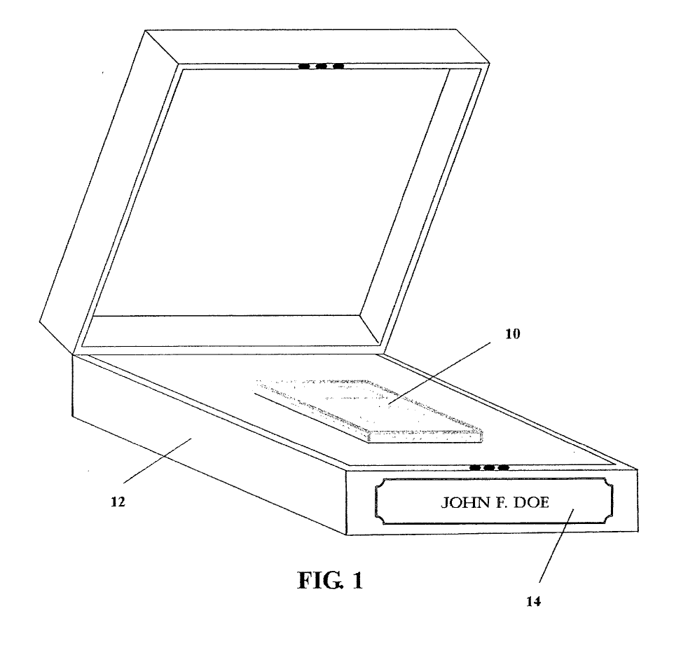

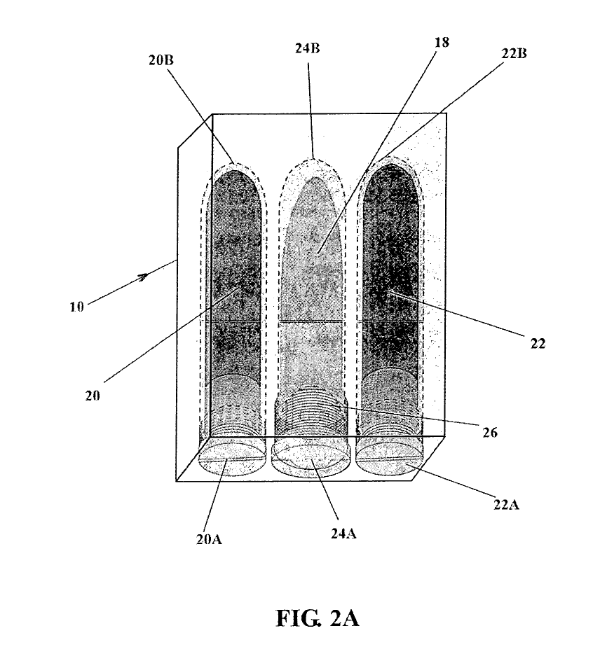

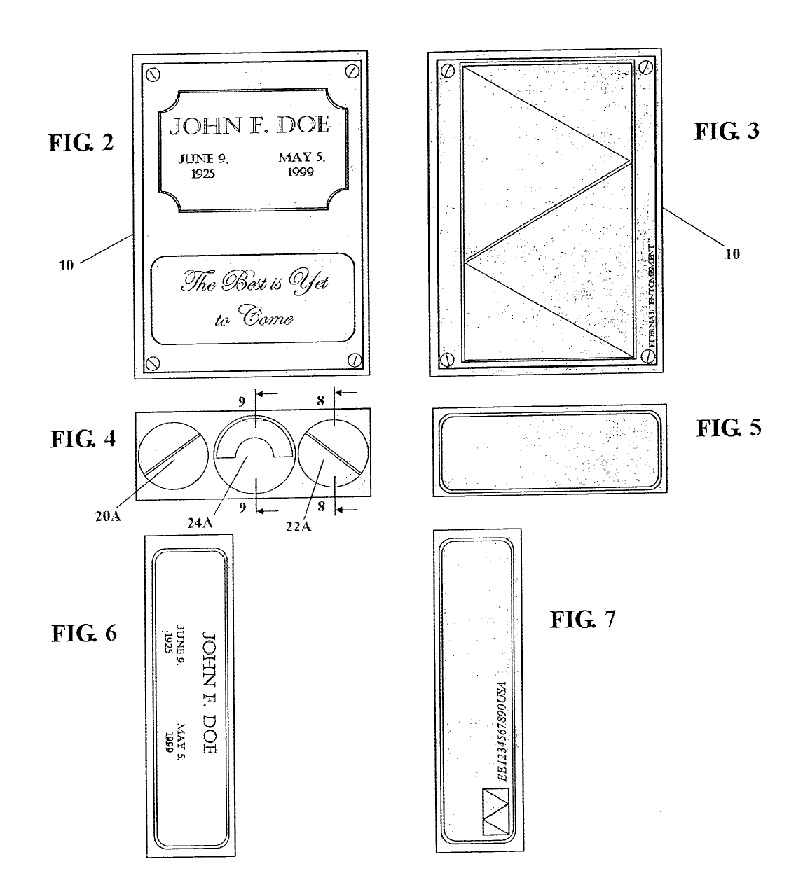

A first embodiment of the new Portable Grave Time Capsule invention is shown in FIGS. 1-10. For convenience in this document this portable grave usually will be called “the capsule.” FIG. 1 shows the capsule 10 in an attractive presentation box 12 with the name of the deceased indicated as “John F. Doe” on a label or plaque 14 at the front of the presentation box. FIGS. 2-7 illustrate various views of the capsule 10, and FIGS. 2A, 8, 8A, 9 and 9A illustrate the internal components of the capsule. As seen in FIGS. 2-7 the capsule 10 is a box-like container preferably made of titanium, brass or stainless steel for its strength and durability. The bottom view of FIG. 4 shows three closures 20A, 22A and 24A which are threaded elements that close and seal three internal compartments or chambers to be described below.

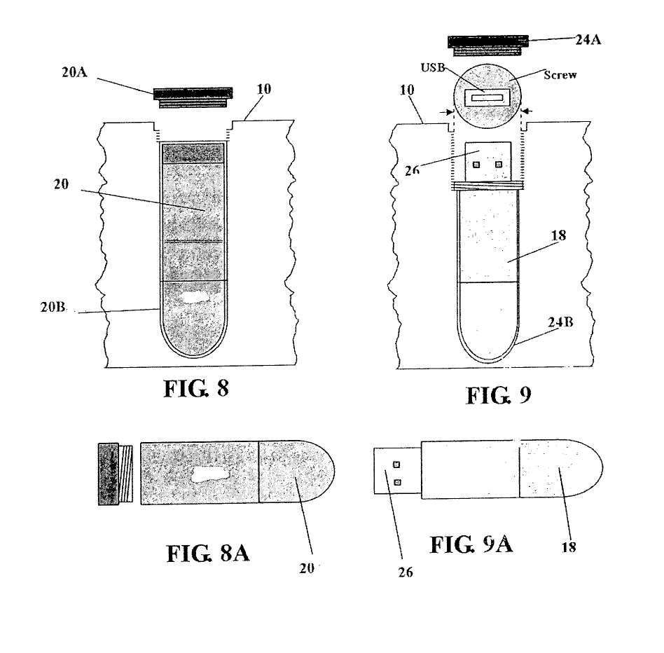

FIG. 2A illustrates the three internal chambers 20B, 22B and 24B in the new time capsule 10. Within chambers 20B and 22B are tubes 20 and 22, respectively, one intended to contain actual DNA material of the deceased, and the other intended to contain cremated ash remains of the deceased. Each tube is sealed, and after it is placed in its chamber, the chamber is sealed with threaded cap closures 20A and 22A respectively. For convenience and clarity, FIGS. 8 and 8A show only tube 20, chamber 20B and cap 20A, but this Figure is representative also of tube 22, chamber 22B and cap 22A seen in FIG. 2A.

Also shown in FIG. 2A and corresponding FIG. 9, is compartment 24B which contains volatile memory chip 18 and USB connector 26 to allow uploading and downloading data into or from memory chip 18. FIG. 9A shows the memory chip 18 and USB connector. As seen in FIGS. 2A, 4 and 9, chamber 22B is closed and sealed by closure or cap 24A.

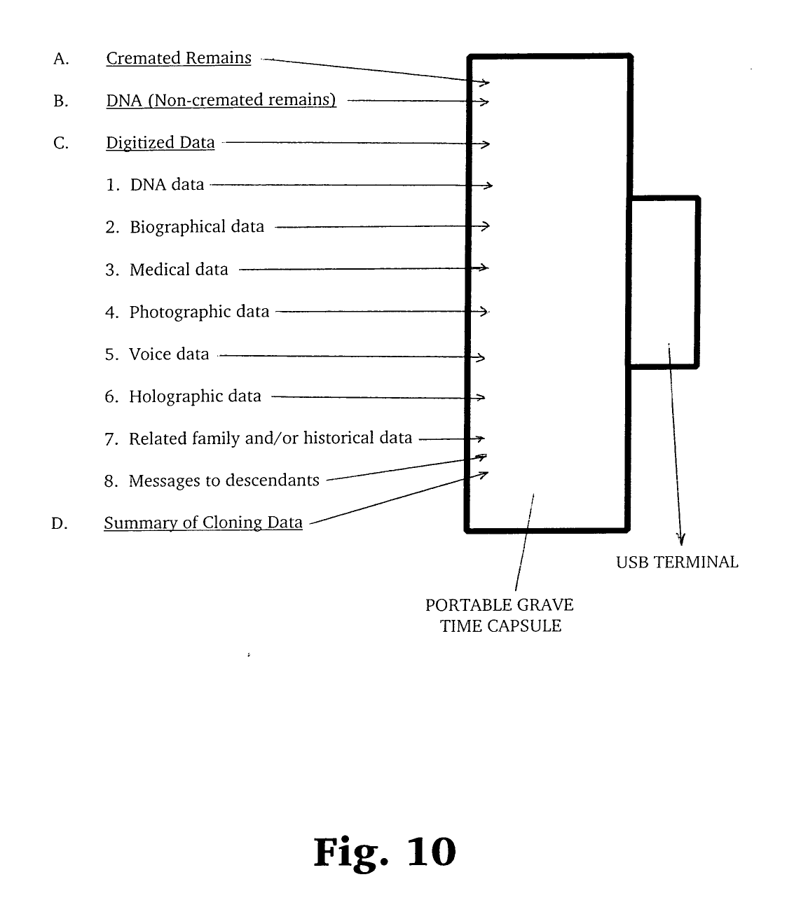

FIG. 10 provides a schematic representation of the contents of the capsule 10 containing:
A. Cremated remains in tube 22
B. DNA non-cremated remains in tube 20
C. Digitized data in memory chip 18, including:
   1. DNA data
   2. Biographical data
   3. Medical data
   4. Photographic data
   5. Voice data
   6. Holographic data
   7. Related family and/or historical data
   8. Messages to descendants
D. Summary of Cloning Data (optional) also in the memory chip 18.

All or some of the above-described digitized data or other data is uploaded into the memory chip 18 of capsule 10 via its USB connector 26. This data is accessible to be downloaded, viewed, studied, supplemented, reorganized, etc., on a typical computer. A descendant or any interested party needs only to link this capsule via a USB or other communications cable to the computer. Also, a plurality of these capsules may be linked one-at-a-time or simultaneously to a computer to affect a family tree, or with appropriate power, software and circuitry individual portable grave capsules may be electronically linked directly to each other.

Once linked for downloading, an observer of a particular portable grave time capsule can observe and/or study all the digitized data therein and/or the DNA data for medical history or identification purposes or for attempted cloning, if and when such is appropriate and possible.

As clearly evident, the data in this portable grave is potentially so vast in depth and form that an observer can visualize, hear and experience the deceased via the physical data, the textual data and the photographic video, voice and holographic data, as an attempt to understand and/or approach the essence of the deceased. Obviously, this mass of data in a relatively tiny and totally portable capsule can be readily transported, displayed, stored and used, and furthermore, reproduced for the most part. The capsule itself is permanently sealed for protection from damage or alteration, except for the permitted downloading of old data and uploading new data. The capsule may be made of a variety of materials, but titanium has been preferred for its recognized strength and very long term durability.

The above described embodiments may take a variety of other forms still within the spirit of this invention and within the scope of the claims appended hereto.

1. A method of burial comprising the steps:
(a) collecting and containing physical remains including cremated ashes and non-cremated DNA material of a deceased person,
(b) collecting in a memory device digitized data on the biographical and/or medical history of said deceased person,
(c) providing a sealable time capsule to contain said physical remains and said digitized data, and
(d) providing a communication terminal on said time capsule for accessing, uploading and downloading said digitized data.

2. A method to enhance the environment by conserving land space and conserving trees, by an alternate form of burial instead of using wooden caskets buried in cemeteries, comprising the steps:
(a) collecting and containing physical remains including cremated ashes and non-cremated DNA material of a deceased person,
(b) collecting in a memory device digitized data on the biographical and/or medical history of said deceased person,
(c) providing a sealable time capsule to contain said physical remains and said digitized data, and
(d) providing a communication terminal on said time capsule for accessing, uploading and downloading said digitized data.

3. Conducting a business of enabling persons to have eternal entombment and memorialization of their lives by a form of burial, comprising the steps:
(a) collecting and containing physical remains including cremated ashes and non-cremated DNA material of a deceased person,
(b) collecting in a memory device digitized data on the biographical and/or medical history of said deceased person,
(c) providing a sealable time capsule to contain said physical remains and said digitized data, and
(d) providing a communication terminal on said time capsule for accessing, uploading and downloading said digitized data.

4. A portable grave time capsule comprising:
(a) a sealable container:
(b) a first chamber in said container for containing a quantity of cremated ash of a deceased person,
(c) a second chamber in said container for containing a quantity of non-cremated DNA material of said deceased person, said non-cremated DNA material being removable from said time capsule.
(d) a memory device in said container for containing digitized data of the medical history data, biographical history data, DNA and/or photographs of said deceased person, and
(e) a communication terminal in said container for downloading said digitized data to a computer and for uploading other data into said memory device,

5. A method for cloning a deceased person comprising:
(a) collecting and containing physical remains including cremated ashes and non-cremated DNA material of a deceased person, said non-cremated DNA material being removable from said time capsule for use in a cloning process,
(b) collecting in a memory device digitized data on the biographical and/or medical history of said deceased person,
(c) providing a sealable time capsule to contain said physical remains and said digitized data, and
(d) providing a communication terminal on said time capsule for accessing, uploading and downloading said digitized data.

6. A portable grave according to claim 4 wherein said container has dimensions of approximately 3⅝″×2⅝″×1″.

7. A portable grave according to claim 4 wherein said communications terminal is linkable to a similar portable grave time capsule of a different deceased person, for transferring digitized data from one portable grave time capsule to the other.

8. A method of creating a family tree by linking to a computer or to each other a plurality of said portable graves as defined in claim 4, whereby said data from said time capsules can be manipulated to produce a family tree.
